(19) United States
(12) Patent Application Publication
(10) Pub. No.: US 2004/0183313 A1
(43) Pub. Date: Sep. 23, 2004

(54) Display case with magnetic latch assembly

(76) Inventors: Robert A. Sherman, Corona, CA (US); Christopher S. Stock SR., Moreno Valley, CA (US)

Correspondence Address: Daniel L. Dawes, Myers Dawes Andras & Sherman LLP, 19900 MacArthur Blvd, Suite 1150, Irvine, CA, 92612, US

(21) Appl. No.: 10/393,110

(22) Filed: Mar. 19, 2003

(51) Int. Cl. E05C 19/16

(52) U.S. Cl. 292/251.5

(57) ABSTRACT

A magnetically engageable latch assembly used for display cases and the like for secure closure that has a male protrusion and a female cavity. Either the male protrusion or the female cavity will have a permanent magnet while the other will have a metal conductor that will attract the permanent magnet due to its magnetic field. The female and male connection prevents movement of the latch assembly in the lateral direction. Alternatively disclosed is a male and female connection that each contains permanent magnets. A plastic stop within the cavity is also disclosed that prevents deterioration of the female cavity.

### BACKGROUND OF THE INVENTION

1. Field of the Invention

The invention relates generally to a magnetically engageable latch assembly and more particularly to a magnetic latch assembly for a display case for showing, storing, displaying and transporting items.

2. Description of the Prior Art

Display cases are commonly used by vendors and collectors to store items including model cars, dolls and eyeglasses. Particular to the display of eyeglasses, a smooth presentation relies heavily on the flawless function of the display case. Accordingly, the artesian in the eyeglass field will want to remove several display cases from a larger carrying case without external components, such as hardware, catching on one another. Also, the artisan will want to open a display case smartly, in a smooth manner, and without distracting noises. In particular the latching mechanism must function optimally, without catching other display cases and without making distracting noises.

The prior art display cases have employed a variety of latching mechanisms. One variety uses a Velcro or hook-in-loop device to secure the display case as illustrated in FIG. 1a. However, Velcro will cause a display case to open noisily which is highly undesirable in a presentation. Another latching mechanism will use snaps to secure a cover or lid of a display case (FIG. 1b). A problem with the snap latching mechanism is that that the external hardware can catch on other display cases, clothes or other objects. Also, the snap is somewhat noisy and does not provide a smooth opening and closing. A snap is also visually conspicuous and makes the appearance of the display case unattractive.

Further developments in the prior art include a flat surface magnetic latch. The magnetic latch in one aspect is an improvement since it opens smoothly and without visible hardware. The flat surface magnet will secure a cover from outward movement; however, it is unable to prevent the cover from sliding laterally. Therefore, if a display case is turned upside down, the flat surface magnet will not be able to remain secured.

In light of this problem, it is an object of the present invention to provide a magnetically engageable latch assembly for a display case that is secure from lateral and outward movement. It is further an object of the present invention to provide a latch mechanism for a display case that can open and close smoothly. Yet another object of the present invention is to provide a magnetic latch assembly design that minimizes the use of external hardware. It is still another object of the invention to provide a magnetic latch assembly that is relatively lightweight with optimum strength. Yet still another object of the present invention is to provide a magnetic latch assembly and method that is relatively easy to manufacture and that is comparatively cost effective.

### SUMMARY OF THE INVENTION

A display case, for showing, storing, displaying and transporting items comprises a case section having a bottom and four sides including an interlocking side. In a preferred embodiment the interlocking side includes one or more male magnetic protrusions. The display case further comprises a pivotable lid section for closure of the display case that has a top portion and an overlap portion. The overlap portion includes one or more female cavities to receive the corresponding one or more male magnetic protrusions.

The female cavities of the invention each have a metal plate that is magnetically attracted to the magnetic protrusions for attaching the overlap portion to the interlocking side using a magnetic field. Additionally, the female cavities each include a plastic stop at the distal end to secure its respective male magnetic protrusion prevent the protrusion from sliding and thereby release the magnetic field. The plastic stops further prevent deterioration of the female cavity walls.

The present invention is also a method of latching a lid to a display case comprising: providing a male magnetic protrusion; providing a female cavity to receive the male magnetic protrusion; providing a metal plate within the female cavity, the metal plate being magnetically attracted to the male magnetic protrusion; and interlocking the male magnetic protrusion with the female cavity to form a connection using an attractive magnetic field. The method further comprises preventing sliding of the connection and deterioration of the female cavity using a plastic stop within the female cavity.

Another method embodied by the present invention includes manufacturing a lid with a magnetic latch assembly useful for securing a display case having a side to be latched, the method comprising: providing a lid made of level surface material having an end portion; folding the end portion over one or more times to form an overlap portion of increased thickness; removing a segment of the level surface material on the overlap portion to form a female cavity; inserting a metal conductive plate in the female cavity; and inserting a male magnetic protrusion inside the female cavity using a magnetic field. This method also includes inserting a plastic stop inside the female cavity to prevent sliding of the male magnetic protrusion inside the female cavity and to prevent deterioration of the female cavity.

In yet another embodiment, the magnets and receiving cavities are reversed. In that case the invention is characterized as a display case comprising: a pivotable lid section for closure of the display case, the pivotable lid section including an overlap portion, and the overlap portion including one or more male magnetic protrusions. The display case also has a case section that has a bottom and four sides including an interlocking side, the interlocking side including one or more female cavities to receive its corresponding one or more male magnetic protrusions. Additionally, the female cavities each have a metal plate the metal plate being magnetically attracted to its respective male magnetic protrusion for attaching the overlap portion to the interlocking side using a magnetic field. Further, the female cavities each include a plastic stop within each cavity at the distal end to secure the one or more male magnetic protrusions and to prevent the male magnetic protrusions from sliding and thereby releasing the magnetic field. Alternatively, the female cavities instead have a second permanent magnet configured to be mutually attractive to the male magnetic protrusions.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWING

The objects, advantages and features of the present invention will become more apparent to those skilled in the art from the following detailed description, when read in conjunction with the accompanying drawings, wherein:

FIG. 1a is a perspective view of a prior art display case having hook and loop latching means;

FIG. 1b is a perspective view of a prior art display case having hardware snaps as latching means;

FIG. 2a is a perspective view of a display case of the present invention showing the lid in a closed position and illustrating sectional line of interest 4-4;

FIG. 2b is perspective view of a display case of the present invention illustrating features of interest with the lid in the open position;

FIG. 3a is a top plane view of a lid of the present invention during the manufacturing process;

FIGS. 3b and 3c are a top plane views of a lid of the present invention during manufacturing showing the addition of metal plates and forming an overlap portion;

FIG. 3d is a perspective view of lid of the present invention;

FIG. 4 is a cross sectional view of an interlocking side engaging a pivotable lid section of the present invention taken along sectional line 4-4;

FIG. 5 is a cross sectional view of a latch assembly of the present invention illustrating an alternative embodiment where the cavity is on the interlocking side.

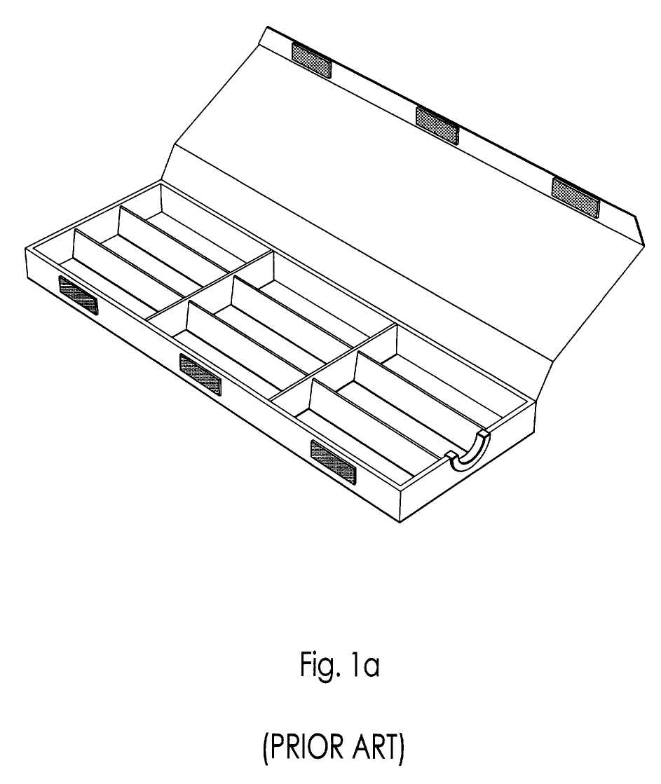

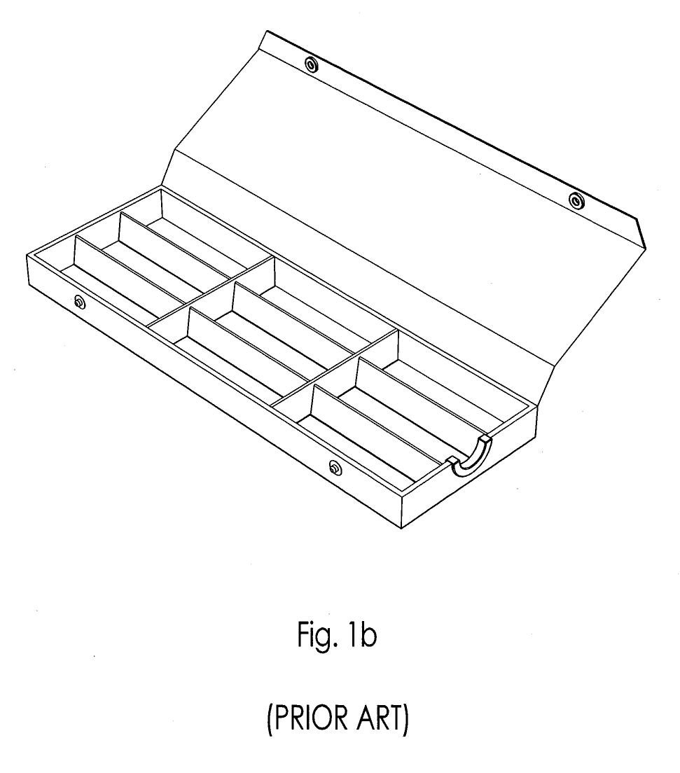

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

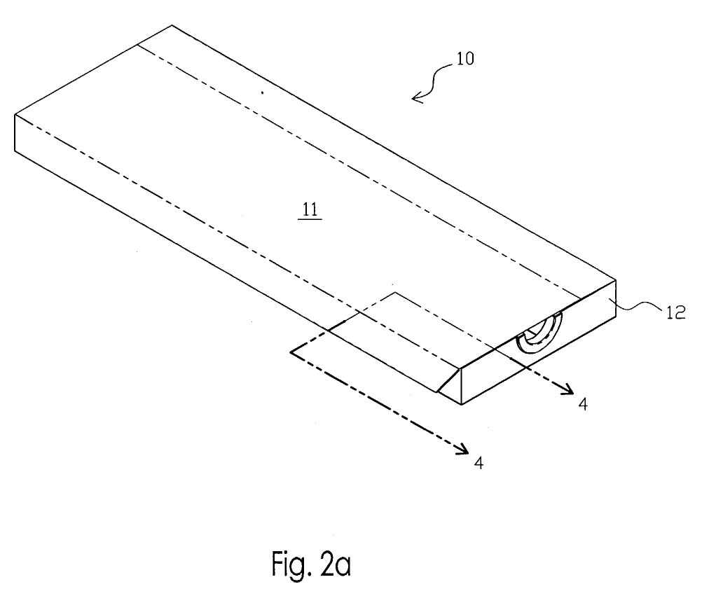

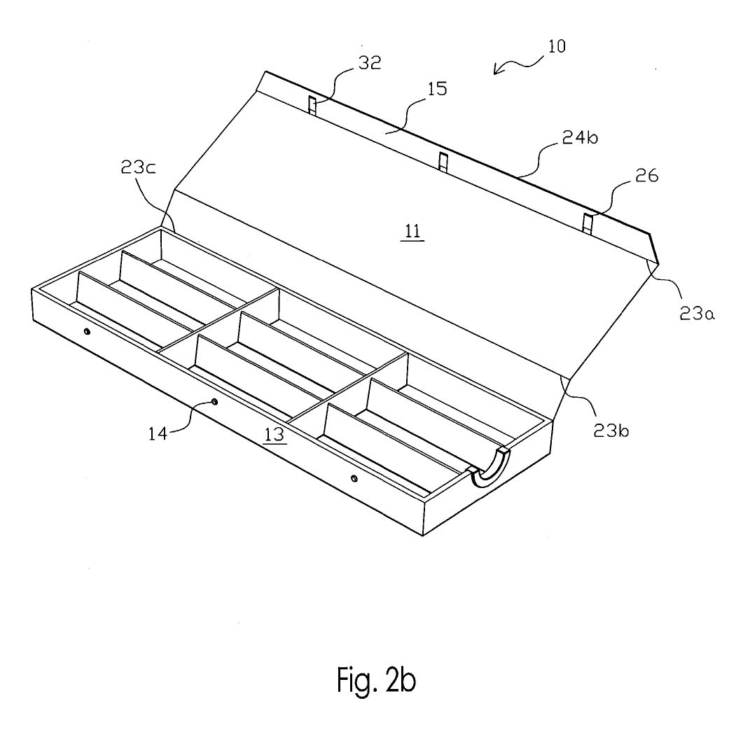

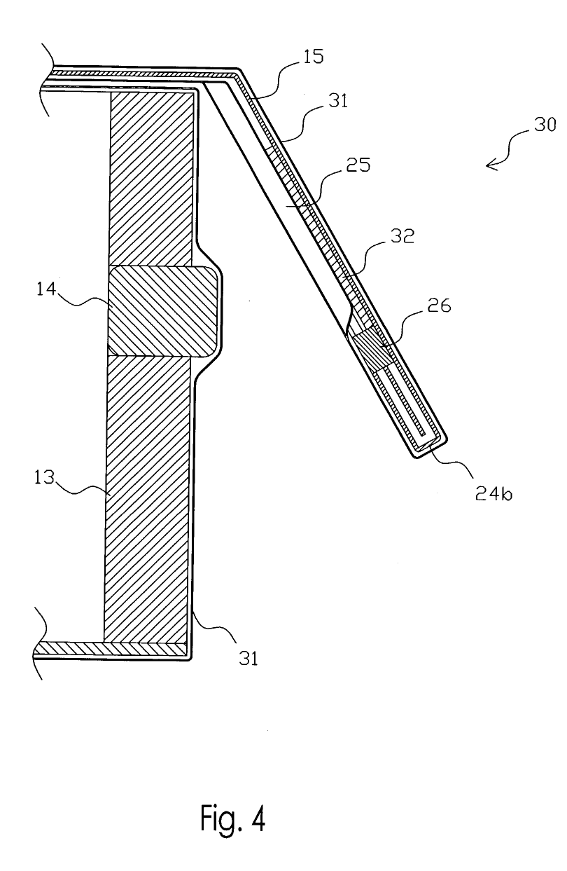

Referring now to FIGS. 2a and 2b, a display case 10 with a magnetic latch assembly embodied by the present invention is illustrated. FIG. 2a shows the display case in the secure position and sectional line of interest 4-4 that contains the magnetic latch assembly of the present invention. FIG. 2b shows the display case 10 of FIG. 2a with a pivotable lid section 11 in the open position. The pivotable lid section 11 has an overlap portion 15 that is configured as part of the magnetic latch assembly 30 (see FIG. 4) of the present invention and engages an interlocking side 13. In a first embodiment, the interlocking side has male magnetic protrusions 14 as part of the magnetic latch assembly 30. By way of illustration, FIG. 2b also shows pivotable lines 23a-c of the pivotable lid section 11. Pivotable line 23b is not critical to this embodiment of the invention, but aids in functioning of the lid section 11. As an example, the lid section 11 is made of cardboard material, and the case section 12 is made of light wood such as bass wood.

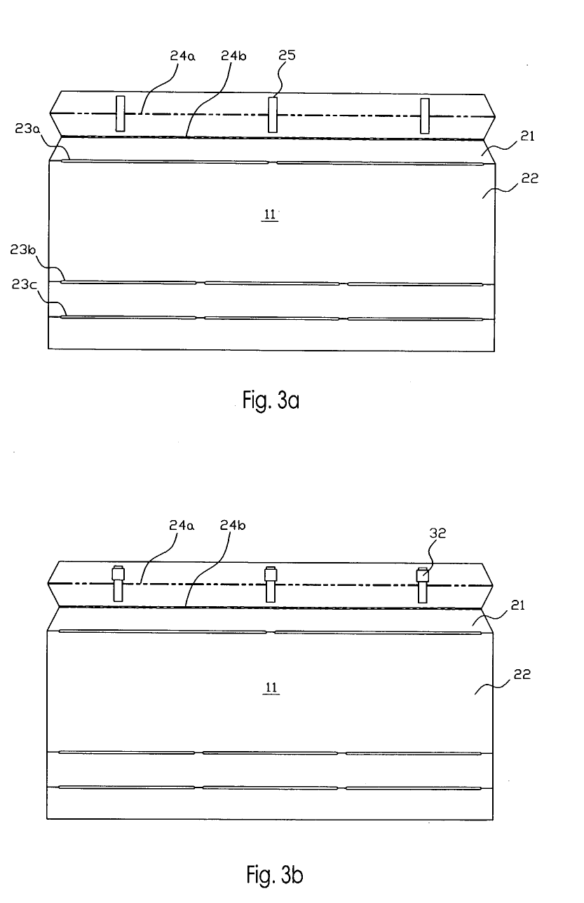

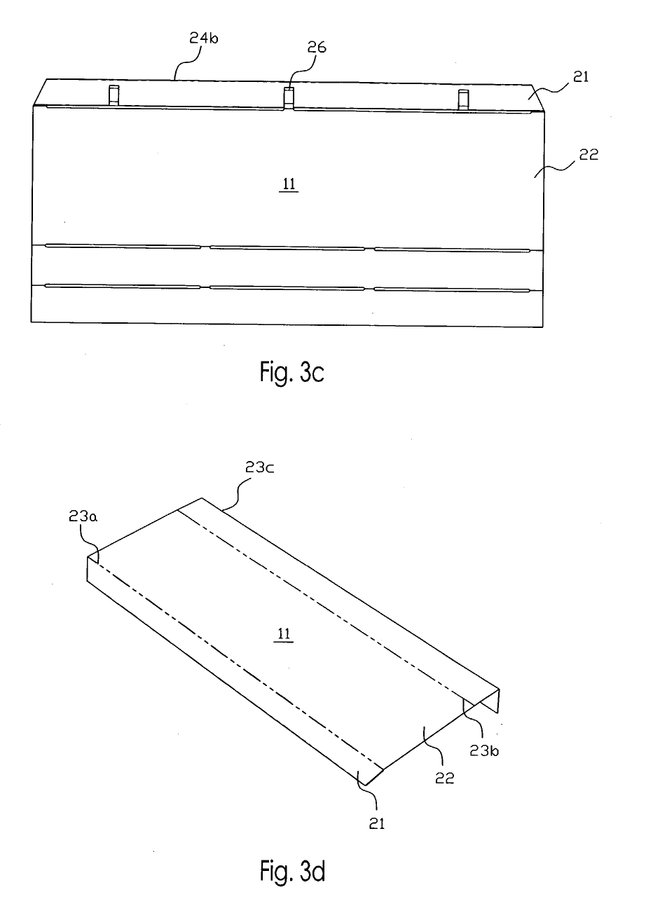

Now referring to FIGS. 3a through 3d, a lid section 11 of the present invention is shown during manufacture. The lid section 11 has an overlap portion 21 and a top portion 22. The overlap portion 21 is shown unfolded along folds 24a and 24b. In the illustration, female cavity 25 has been cut out of the material of the lid section. The overlap portion is initially folded along fold 24a and through the center of the female cavity 25 after metal plate 32 is inserted between the folds (FIGS. 3b and 3c). Next, the overlap portion is folded along fold 24b, and plastic stop 26 is added (FIG. 3c). The double fold, in this particular embodiment, allows for a deep cavity 25 for added support. FIG. 3d illustrates a perspective view of the lid 11.

Now referring to FIG. 4, a cross sectional view of a magnetic latch assembly 30 of the present invention is shown as taken along section line 4-4 of FIG. 2a. In this embodiment, female cavity 25 is configured to receive the male magnetic protrusion 14 as shown. The male protrusion 14 has permanent magnetic polarization forming a magnetic field. A metal plate 32 is configured within overlap portion 15 as shown. More specifically, metal plate 32 can be made of any substance attracted toward a region of stronger magnetic field. This attraction secures the magnetic latch assembly 30 in the outward direction. The female cavity 25 prevents movement of the overlap portion 15 in the lateral and upward directions. Plastic stop 26, alternatively made from any suitable material, prevents deterioration of the cavity 25 walls and further secures the overlap portion 15 in the upward direction. The display case 10 is covered on the exterior by a fabric material 31 as well as on both sides of the lid portion 11. Fabric material 31 further is useful to hide the components of the magnetic latch assembly 30 to improve appearance and improve presentation of the display case 10.

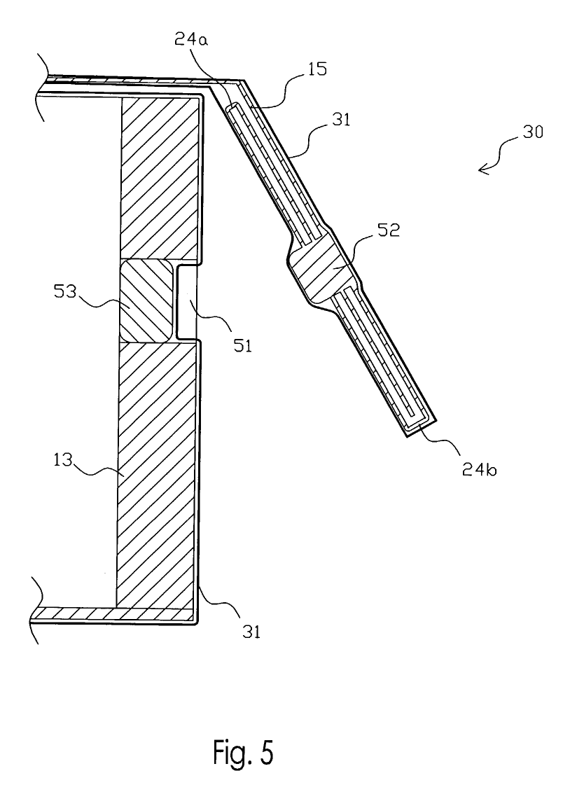

Referring to FIG. 5, an alternative embodiment is illustrated that is a cross-sectional view of a magnetic latch assembly 30. In this case, the female cavity 51 is on the interlocking side of the display case and the male protrusion 52 is on the overlap portion 15 of lid 11. Recessed magnet 53 is shown, however magnet 53 could alternatively be metal and the male protrusion 52 could be magnetized.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A display case, for showing, storing, displaying and transporting items comprising:
a case section having a bottom and four sides including an interlocking side, said interlocking side including one of a male protrusion or a female cavity; and
a pivotable lid section for closure of the display case, said pivotable lid section including a top portion and an overlap portion, said overlap portion including the other of a female cavity or a male protrusion not included in said interlocking side to receive corresponding said protrusion or cavity, wherein the female cavity and the male protrusion are formed from a magnetic material or a metal material and configured so that the cavity and the protrusion are magnetically attracted to each other using a magnetic field.

2. The display case of claim 1, wherein said female cavity includes a plastic stop within the female cavity at the distal end to secure said male protrusion and to prevent said male protrusion from sliding and thereby releasing the magnetic field.

3. The display case of claim 1, wherein said pivotable lid section has a first pivot between said overlap portion and said top portion, and wherein said lid section has a second pivot in said top portion to facilitate opening and closing of the display case.

4. The display case of claim 1, further comprising fabric material covering the case section and the pivotable lid section.

5. A method of latching a lid to a display case comprising:
providing a male magnetic protrusion;
providing a female cavity to receive the male magnetic protrusion;
providing a metal plate within the female cavity, the metal plate being magnetically attracted to the male magnetic protrusion; and
interlocking the male magnetic protrusion with the female cavity to form a connection using an attractive magnetic field.

6. The method of claim 5, and further comprising the step of preventing sliding of the connection using a plastic stop within the female cavity.

7. The method of claim 5, and further comprising preventing deterioration of the female cavity using a plastic stop within the female cavity.

8. A method of manufacturing a lid with a magnetic latch assembly useful for securing a display case having a side to be latched, the method comprising:
providing a lid made of level surface material having an end portion;
folding the end portion over one or more times to form an overlap portion of increased thickness;
removing a segment of the level surface material on the overlap portion to form a female cavity;
inserting a metal conductive plate in the female cavity; and
inserting a male magnetic protrusion on the side to be latched of the display case wherein the male magnetic protrusion can be secured inside the female cavity using a magnetic field.

9. The method of claim 8, and further comprising inserting a plastic stop inside the female cavity to prevent sliding of the male magnetic protrusion inside the female cavity and to prevent deterioration of the female cavity.

10. The method of claim 8, and further comprising covering the lid with fabric material.
